(19) United States
(12) Patent Application Publication
(10) Pub. No.: US 2005/0271194 A1
(43) Pub. Date: Dec. 8, 2005

(54) Conference phone and network client

(76) Inventors: Paul R. Woods, Corvallis, OR (US); Patrick A. McKinley, Corvallis, OR (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/863,308

(22) Filed: Jun. 7, 2004

(51) Int. Cl. H04M 3/42; H04Q 11/00; H04B 7/00; H04L 12/16; H04Q 7/20

(52) U.S. Cl. 379/202.01; 455/518

(57) ABSTRACT

A conference phone system includes personal headsets and a base unit. The personal headsets individually capture audios of local participants on a conference call (“local audios”) and transmit the local audios in separate and identifiable channels to the base unit. The base unit receives the local audios and transmits the local audios in separate and identifiable audio streams over a network to a network client. For a remote participant on the conference call, the network client reproduces the local audios and indicates one or more participants who are presently speaking. The network client can also virtualize the local audios so that the remote participant can distinguish the participants by their relative positions, whether virtual or actual. The network client uses the audio source identification information of various participants to enable conference features to mute, enhance, or hold private sidebar conversations.

### DESCRIPTION OF RELATED ART

Teleconferencing enables people separated geographically to hold meetings through the use of telephone, closed-circuit TV, and network-based tools for sharing visual materials such as slides and whiteboards. Due to band width and equipment limitations, teleconference participants often miss out on much of the information available in the local meeting to in-meeting participants. This is especially true when in-meeting participants meet in person in the local meeting and teleconference with one or more remote participants. While tools such as NetMeeting and WebEx attempt to address some of the problems, namely data sharing and video, they do not address the audio difficulties of a teleconference.

Low quality audio plagues users of conference phones. Remote meeting participants, already at a disadvantage when they cannot see the visual cues and expressions of the other people in the meeting, also must contend with distractions such as the person speaking being too far away from the microphone, too many people speaking at the same time, and machine noise form laptops and overhead projectors.

In-person participants are also exposed to these distractions, but naturally filter them out by reading lips and turning the head to hear well. On the remote end, the user hears all the audio to which the conference phone is exposed and is not able to filter out distractions as one would do in person. Thus, what are needed are an apparatus and a method that overcome some of these audio-related teleconferencing problems.

### SUMMARY

In one embodiment of the invention, a conference phone system includes wireless or wired headsets and a base unit. These personal headsets individually capture audios of local participants on a conference call (“local audios”) and transmit the local audios in separate and identifiable channels to the base unit. The base unit receives the local audios and transmits the local audios in separate and identifiable audio streams over a network to a network client. For a remote participant on the conference call, the network client reproduces the local audios and indicates one or more participants who are presently speaking. The network client can also virtualize the local audios so that the remote participant can distinguish the participants by their relative positions, whether virtual or actual. Furthermore, the network client can solo, enhance, or mute any one local participant, or hold a sidebar conversation between the remote participant and any one local participant.

### BRIEF DESCRIPTION OF THE DRAWINGS

FIG. 1 illustrates a conference phone system in one embodiment of the invention.

FIGS. 2, 3, 4, 5, 6, and 7 illustrate methods for operating the conference phone system of FIG. 1 in embodiments of the invention.

Use of the same reference numbers in different figures indicates similar or identical elements.

### DETAILED DESCRIPTION

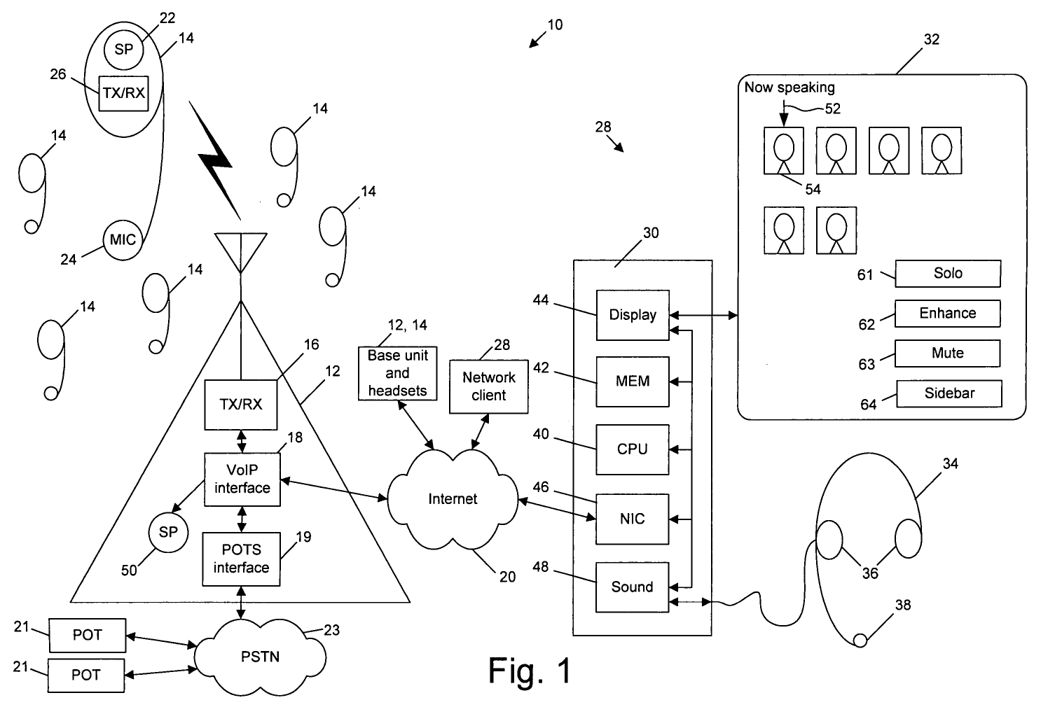

FIG. 1 illustrates a conference phone system 10 in one embodiment of the invention. Conference phone system 10 includes a base unit 12 and multiple wireless headsets 14. The base unit includes a radio transceiver 16 (e.g., a Bluetooth transceiver) capable of handling multiple audio channels and a VoIP (Voice-over-Internet Protocol) interface 18 to a network 20 (e.g., the Internet). Each wireless headset 14 includes a speaker 22, a microphone 24, and a radio transceiver 26 (e.g., a Bluetooth transceiver). Each wireless headset 14 uses a separate and identifiable channel so that base unit 12 can associate a given audio stream to a given headset 14. Base unit 12 can further include a POTS (plain old telephone system) interface 19 for connecting to POTs (plain old telephones) 21 via a telephone network 23 (e.g., a public switched telephone network).

On the remote end, each network client 28 includes a computer 30, a monitor 32, and a stereo headset 34. Computer 30 includes a CPU 40 for executing a teleconference application, a memory 42 for storing the GUI application and related data, a display card 44 for rendering the GUI on monitor 32, a NIC (network interface card) 46 for connecting to network 20, and a sound card 48 for reproducing and capturing audio on headset 34. The teleconference application handles the VoIP audio connection, generates a graphic user interface on monitor 32, feeds audio to stereo speakers 36 of headset 34, captures the user's voice via a microphone 38 of headset 34, and transmits the local audio via the VoIP. As shown, multiple network clients 28 can be connected to base unit 12 via network 20.

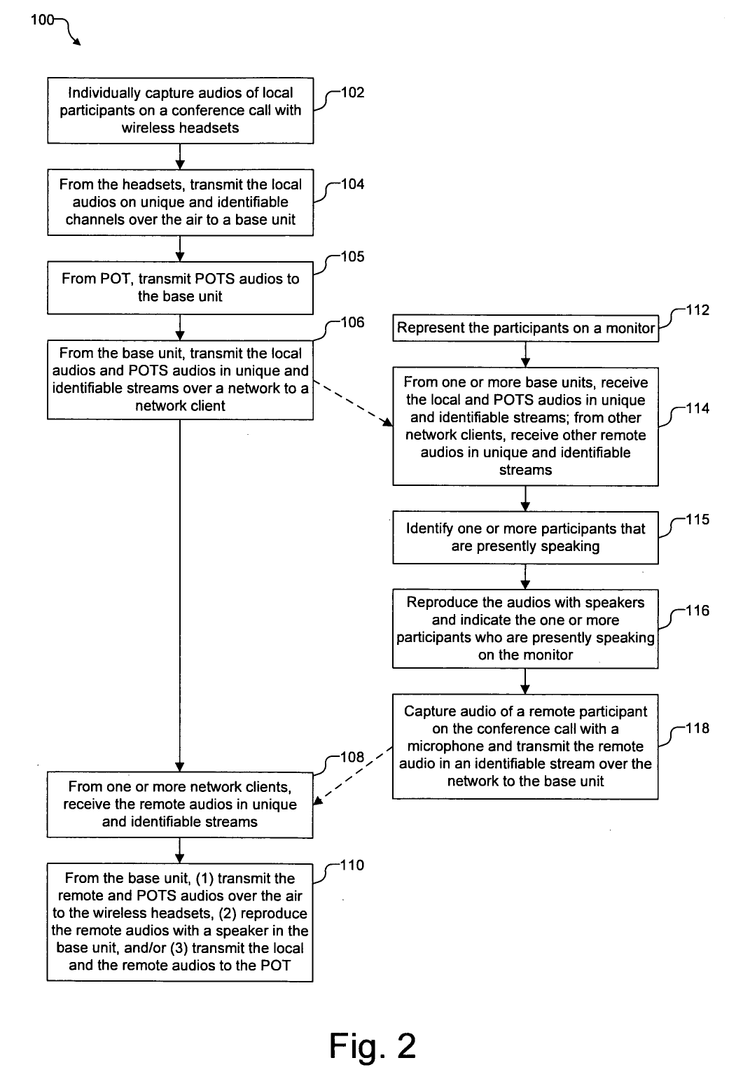

FIG. 2 illustrates a method 100 for holding a conference call among local participants at one or more base units, one or more remote participants using network clients, and one or more telephonic participants using POTs in one embodiment of the invention. Method 100 is divided between (1) actions 102 to 110 taken by wireless headsets 14 and a base unit 12 at a local site, and (2) actions 112 to 118 taken by a network client 28 at a remote site. At each local site, local participants are meeting in person about a base unit 12 and is each equipped with a wireless headset 14. At each remote site, a remote participant uses network client 28 to participate in the conference call.

In step 102, wireless headsets 14 uses microphones 24 to individually capture the voices of the local participants.

In step 104, wireless headsets 14 uses radio transceiver 26 to transmit the voices in unique and identifiable channels to base unit 12. As the voices are transmitted in separate and identifiable channels, base unit 12 can use radio transceiver 16 to associate a given audio stream to a given headset 14 used by a given local participant.

In step 105, one or more POTs 21 transmits the voices of the telephonic participants over POTS network 23 to POTS interface 19 of base unit 12. With the caller ID enabled, base unit 12 can use POTS interface 19 to associate a given audio stream to a given POT used by a given telephonic participant.

In step 106, base unit 12 uses VoIP interface 18 to transmit the local audios of the local participants and the POTS audios of the telephonic participants over network 20 to network clients 28 and other base units 12, if any. In one embodiment, VoIP interface 18 transmits the audios of each local participant and each telephonic participant in separated and identifiable audio streams (e.g., in separate packets with headers identifying the local or telephonic participants) to network clients 28 and other base units 12.

In step 108, base unit 12 uses VoIP interface 18 to receive remote audios from network clients 28 and other local audios from other base units 12. In one embodiment, the audios from each remote participant and each local participant of other base units 12 are received in separate and identifiable audio streams.

In step 110, base unit 12 uses radio transceiver 16 to transmit the remote audios and the other local audios to wireless headsets 14. Alternatively or in addition to the wireless transmission, base unit 12 may include a speaker 50 that broadcasts the remote audio and the other local audios to the local participants. Furthermore, base unit 12 uses POTS interface 19 to transmit the remote audios, the local audios, and the other local audios to POTs 21 for the telephonic participants.

Steps 102 to 110 are repeated for the duration of the conference call by each participating base unit 12. Although shown separate and in sequence, these steps may be carried out concurrently or in different order in accordance with the flow of the conversation.

Now turning to the action taken by each network client 28, in step 112, network client 28 represents the local participants having wireless headsets 14 on monitor 32. For example, referring back to FIG. 1, there may be six participants (whether local, telephonic, or other remote participants) so network client 28 (more specifically CPU 40) instructs display card 44 to generate a GUI having six icons representing the six participants on monitor 32. Note that the relative positions of the icons on monitor 32 do not necessarily reflect the relative positions of any local participants at a local site.

The remote participant can manually determine which participant is using which headset and provide identifiable features for the icon (e.g., names and/or pictures of the local participants). Alternatively, base unit 12 may be preconfigured with the names of the local participants and provide it to network client 28 to automatically generate GUI icons with default name and/or pictures of the local participants.

In step 114, network client 28 (more specifically CPU 40) uses NIC 46 to receive the local audios of the local participants and POTS audios of the telephonic participants in separate and identifiable audio streams over network 20 from base units 12. Network client 28 can also use NIC 46 to receive remote audios from other network clients 28, if any.

In step 115, network client 28 (more specifically CPU 40) identifies one or more of the local participants, the telephonic participants, and other remote participants who are presently speaking. Network client 28 identifies a participant as one who is presently speaking when the volume of his or her audio stream exceeds a threshold.

In step 116, network client 28 (more specifically CPU 40) uses sound card 48 to send the local audios, POTS audios, and other remote audios to speakers 36 of headset 34. Furthermore, network client 28 uses display card 44 to visually indicate on monitor 32 the one or more local participants, telephonic participants, and remote participants who are presently speaking. For example, referring back to FIG. 1, an arrow 52 is used to indicate a local participant 54 who is presently speaking.

In step 118, network client 28 (more specifically CPU 40) uses microphone 38 of headset 34 to capture the voice of the remote participant. Network client 28 then uses sound card 48 to convert the voice into a remote audio stream. Finally, network client 28 uses NIC 46 to transmit the audios of the remote participant in an identifiable audio stream (e.g., in packets with headers identifying the remote participant) over network 20 to base units 12 and other network clients 28.

Steps 112 and 118 are repeated for the duration of the conference call. Although shown separate and in sequence, these steps may be carried out concurrently or in different order in accordance with the flow of the conversation.

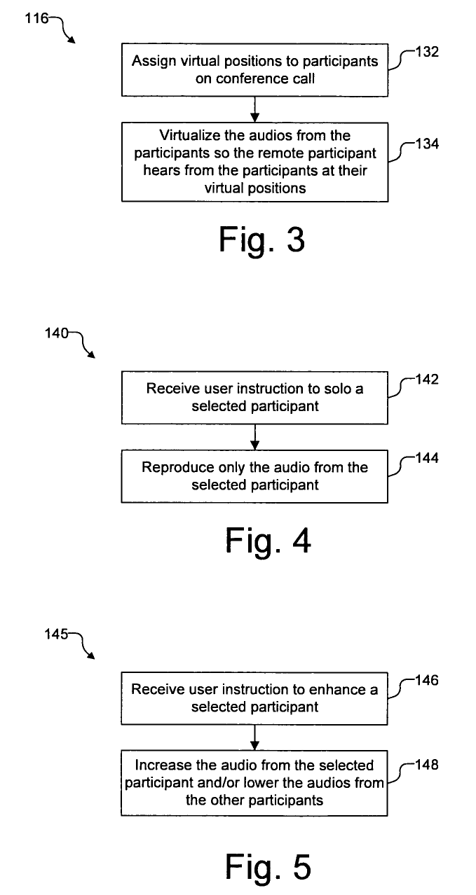

FIG. 3 illustrates one embodiment of step 116 that manipulates the local audio streams so that the remote participant hears the various speakers in different virtual locations in order to better identify the individual speakers. The virtual location is established in a sound field created by the headphone speakers by adjusting the relative volume, phase, and other audio characteristics of the speakers.

In step 132, network client 28 (more specifically CPU 40) assigns a virtual position to each participant in the conference call. In one embodiment, network client 28 can assign the virtual positions according to the relative positions of the icons representing the participants on monitor 32.

In step 134, network client 28 (more specifically CPU 40) uses sound card 48 to perform a 2-speaker 3D virtualization of the audio streams according to the virtual positions of the participants. Virtualization of the audio streams includes adjusting the stereo effect and the phase effect of the sound so that the remote participant hears each participant in a unique virtual position. The virtualized audio is transmitted from sound card 48 to stereo speakers 36 of headset 34.

FIG. 4 illustrates a method 140 for a solo feature of conference phone system 10 in one embodiment of the invention.

In step 142, network client 28 (more specifically CPU 40) receives an instruction from the remote participant to solo one participant (local, telephonic, or another remote participant). Referring back to FIG. 1, the remote participant can do this by selecting a solo button 61 and then selecting the icon representing the one participant that he or she wishes to solo.

In step 144, network client 28 (more specifically CPU 40) instructs sound card 48 to only reproduce the audio stream from the selected participant until the remote participant deactivates the solo feature. Thus, the remote participant will only hear the voice of the selected participant.

FIG. 5 illustrates a method 145 for an audio enhance feature of conference phone system 10 in one embodiment of the invention.

In step 146, network client 28 (more specifically CPU 40) receives an instruction from the remote participant to enhance one participant (local, telephonic, or another remote participant). Referring back to FIG. 1, the remote participant can do this by selecting an enhance button 62 and then selecting the icon representing the one participant that he or she wishes to enhance.

In step 148, network client 28 (more specifically CPU 40) instructs sound card 48 to increase the volume of the selected participant and/or lowers the volumes of the other participants so the remote participant can hear the selected participant better. Network client 28 will continue to do this until the remote user deactivates the enhance feature.

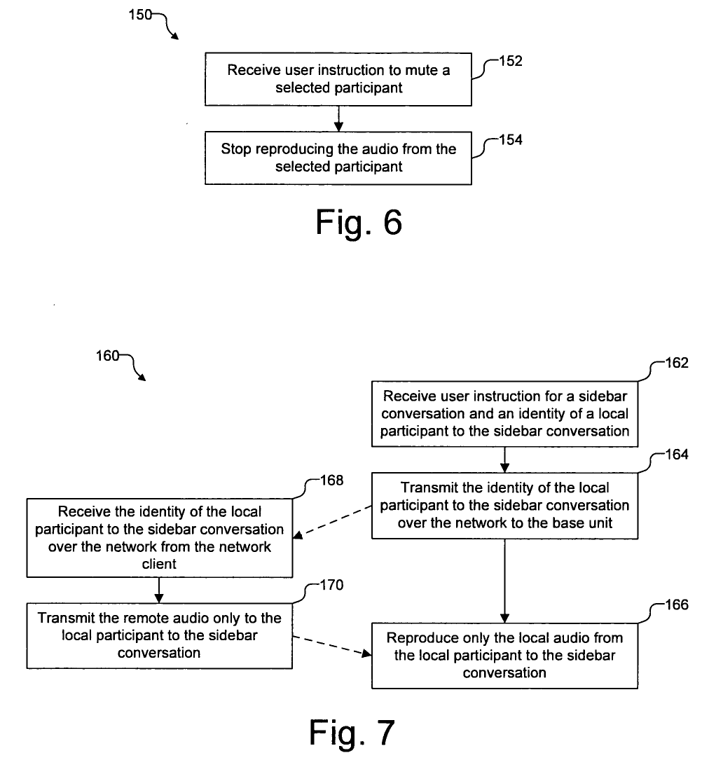

FIG. 6 illustrates a method 150 for a mute feature of conference phone system 10 in one embodiment of the invention.

In step 152, network client 28 (more specifically CPU 40) receives an instruction from the remote participant to mute one participant (local, telephonic, or another remote participant). Referring back to FIG. 1, the remote participant can do this by selecting a mute button 63 and then selecting the icon representing the one participant that he or she wishes to mute.

In step 154, network client 28 (more specifically CPU 40) instructs sound card 48 to stop reproducing the audio from the selected participants until the remote participant deactivates the mute feature. Thus, the remote participant will not hear the voice of the selected participant.

FIG. 7 illustrates a method 160 for a sidebar conversation feature of conference phone system 10 in one embodiment of the invention.

In step 162, network client 28 (more specifically CPU 40) receives an instruction from the remote participant to initiate a sidebar conversation with one of the participants. Referring back to FIG. 1, the remote participant can do this by selecting a sidebar button 64 and then selecting the icon representing the only participant that he or she wishes to have a sidebar conversation with.

In step 164, network client 28 (more specifically CPU 40) uses NIC 46 to transmit the identity of the selected participant over network 20 to a base unit 12 or another network client 28 where the selected participant is located.

In step 166, network client 28 (more specifically CPU 40) instructs sound card 48 to only reproduce the audio stream from the selected participant until the remote participant deactivates the sidebar conversation feature. Alternatively, network client 28 lowers the volume of the other participants so that the remote participant can hear the selected participant better.

In step 168, base unit 12 or another network client 28 (where the selected participant is located) receives the identity of the selected participant to the sidebar conversation.

In step 170, base unit 12 or another network client 28 (where the selected participant is located) only transmits the remote audio stream from the requesting network client 28 to the headset of the selected participant. If the selected participant is a telephonic participant at base unit 12, base unit 12 only transmits the remote audio stream from the requesting network client 28 to the POT 21 that the selected participant is using.

Steps 162 to 170 are repeated for the duration of the sidebar conversation. Although shown separate and in sequence, some of these steps may be carried out concurrently or in different order in accordance with the flow of the conversation.

With each participant in the local site now wearing microphone headsets, sound quality is improved for both the remote and the local participants. Furthermore, the use of wireless headsets that broadcast over identifiable channels allows the current speaker to be visually identified for the remote participant. Along with visual indication of who is presently speaking, the audio signals are virtualized so that the remote participant hears the various speakers in different virtual locations in order to better identify the individual speakers. Additionally, the use of wireless headsets that broadcast over identifiable channels allows for features such as solo, enhance, muting, and sidebar conversations.

Various other adaptations and combinations of features of the embodiments disclosed are within the scope of the invention. Although wireless headsets are described above, the above system and methods are equally applicable to wired headsets that transmit over identifiable channels to the base unit. Numerous embodiments are encompassed by the following claims.

1. A method for a base unit to hold a conference call for local participants, comprising:
individually capturing audios of the local participants (“local audios”); and
transmitting the local audios in separate and identifiable audio streams over a network to a network client.

2. The method of claim 1, wherein said individually capturing audios of the local participants comprising wirelessly receiving the local audios in separate and identifiable channels from wireless headsets used by the local participants.

3. The method of claim 2, further comprising:
receiving an identifiable audio stream of a remote participant of the conference call (“remote audio”) over the network from the network client; and
reproducing the remote audio to the local participants, wherein said reproducing is selected from the group consisting of reproducing the remote audio with a speaker and wirelessly transmitting the remote audio to the wireless headsets used by the local participants.

4. The method of claim 1, further comprising:
receiving an audio of a telephonic participant on the conference call (“POTS audio”) over a telephone network from a POT (plain old telephone);
transmitting the POTS audio in an identifiable audio stream over the network to the network client;
receiving an identifiable audio stream of a remote participant of the conference call (“remote audio”) over the network from the network client; and
transmitting the local audio and the remote audio over the telephone network to the POT.

5. A method for a network client to hold a conference call for a remote participant, comprising:
representing participants of the conference call on a monitor;
receiving audios of participants in separate and identifiable audio streams over a network;
monitoring volumes of the audios;
when a volume of one audio exceeds a threshold, indicating one corresponding participant as presently speaking on the monitor; and
reproducing the audios to the remote participant.

6. The method of claim 5, wherein said reproducing the audios to the remote participant comprises virtualizing the audios on stereo speakers to distinguish between the participants.

7. The method of claim 5, further comprising only reproducing an audio from one participant in response to an instruction from the remote participant to solo said one participant.

8. The method of claim 5, further comprising enhancing an audio from one participant in response to an instruction from the remote participant, said enhancing being selected from the group consisting of increasing the volume of the audio from said one participant and decreasing the volume of the audios from the participants except said one participant.

9. The method of claim 5, further comprising stop reproducing an audio from one participant in response to an instruction from the remote participant to mute said one participant.

10. The method of claim 5, further comprising transmitting an audio of the remote participant (“remote audio”) in an identifiable audio stream over the network to a base unit.

11. The method of claim 5, further comprising, in response to an instruction for a sidebar conversation with one participant:
transmitting an identity of said one local participant to participate in the sidebar conversation over the network; and
reproducing only an audio from said one participant.

12. The method of claim 5, wherein at least one of the participants is selected from the group consisting of another remote participant at another network client, a local participant at a base unit connected to the network client over the network, and a telephonic participant connected to the base unit.

13. A conference phone system, comprising:
headsets individually (a) capturing audios of local participants on a conference call (“local audio”) and (b) transmitting the local audio in a separate and identifiable channel; and
a base unit (a) receiving local audios from the headsets, and (b) transmitting the local audios in separate and identifiable audio streams over a network to a network client.

14. The system of claim 13, wherein:
the headsets each comprises (a) a microphone for capturing the local audio of a local participant, and (b) a radio transmitter for transmitting the local audio to the base unit in the separate and identifiable channel; and
the base unit comprises:
(a) a radio receiver for receiving the local audios from the headsets, and
(b) a VoIP (Voice-over-Internet Protocol) interface for:
(1) transmitting the local audios in separate and identifiable audio streams over the network to the network client; and
(2) receiving an identifiable audio stream of a remote participant on the conference call (“remote audio”) over the network from the network client.

15. The system of claim 14, wherein:
the base unit further comprises a radio transmitter for transmitting the remote audio to the headsets; and
the headsets each further comprises (c) a radio receiver for receiving the remote audio from the base unit, and (d) a speaker for reproducing the remote audio.

16. The system of claim 15, wherein the base unit further comprises a speaker for reproducing the remote audio.

17. The system of claim 14, wherein the VoIP interface further receives, over the network from the network client, an identifiable audio stream of a remote participant on the conference call (“remote audio”) and an identity of a selected local participant to receive the remote audio in a sidebar conversation, the base unit further comprising a radio transmitter that transmits the remote audio only to a wireless headset of the selected local participant in response to receiving the identity of the selected local participant.

18. The system of claim 14, wherein:
the base unit further comprises (c) a POTS (plain old telephone system) interface for receiving an audio of a telephonic participant on the conference call (“POTS audio”) over a telephone network from a POT (plain old telephone), the VoIP interface further transmitting the POTS audio in a separate and identifiable audio stream over the network to the network client;
the base unit further comprising a radio transmitter for transmitting the POTS audio to the wireless headsets; and
the POTS interface further transmits the local audios and the remote audio to the POT.

19. A conference phone system, comprising a network client for a remote participant on a conference call, the network client (a) representing participants on the conference call on a monitor, (b) receiving, over the network, audios of the participants in separate and identifiable audio streams, (c) indicating one or more participants who are presently speaking on the monitor when volumes of their audio streams exceed a threshold, and (d) reproducing the audios to the remote participant.

20. The system of claim 19, wherein the network client further includes a stereo headset and said reproducing comprises virtualizing the audios to the stereo headset to distinguish between the participants.

21. The system of claim 19, wherein the network client only reproduces an audio from one participant in response to an instruction from the remote participant to solo said one participant.

22. The system of claim 19, wherein in response to an instruction from the remote participant to enhance an audio of one participant, the network client increases a volume of the audio from said one participant or decreases volumes of the audios from the participants except said one participant.

23. The system of claim 19, wherein the network client stops reproducing an audio from one participant in response to an instruction from the remote participant to mute said one participant.

24. The system of claim 19, wherein the network client, in response to a user instruction for a sidebar conversation with one participant:
transmitting an audio of the remote participant (“remote audio”) and an identity of said one local participant to receive the remote audio in the sidebar conversation over the network; and
reproducing only an audio of said one participant.
